(19) United States
(12) Patent Application Publication
(10) Pub. No.: US 2026/0163281 A1
(43) Pub. Date: Jun. 11, 2026

(54) ELECTRICAL CONNECTOR WITH IMPROVED TERMINALS

(71) Applicant: FOXCONN INTERCONNECT TECHNOLOGY LIMITED, Grand Cayman (KY)

(72) Inventor: SHUO-HSIU HSU, Phoenix, AZ (US)

(21) Appl. No.: 18/976,875

(22) Filed: Dec. 11, 2024

(51) Int. Cl. H01R 13/24; H01R 12/71; H01R 13/428; H01R 13/50

(52) U.S. Cl. CPC H01R 13/24; H01R 12/714; H01R 13/428; H01R 13/50

(57) ABSTRACT

An electrical connector includes: an insulating housing having plural receiving passages and retaining slots; and plural conductive terminals received in corresponding receiving passages; wherein each of the conductive terminals includes an upper piece and a lower piece, the upper piece includes an upper retaining portion retained in the retaining slot, an upper elastic arm, an upper contacting portion above the upper face, and an upper connecting portion slanting downwards from the upper retaining portion, the lower piece includes a lower retaining portion retained in the retaining slot and below the upper retaining portion, a lower elastic arm, a lower contacting portion below the lower face, and a lower connecting portion slanting upwards from the lower retaining portion, and the upper connecting portion mechanically and electrically connects with the lower retaining portion and the lower connecting portion mechanically and electrically connects with the upper retaining portion.

### BACKGROUND OF THE INVENTION

### 1. Field of the Invention

The present invention relates to an electrical connector with improved terminals.

### 2. Description of Related Arts

U.S. Pat. No. 7,862,343 B2 disclose an electrical connector, the electrical connector includes an insulating housing having a plurality of passageways extending through the top and bottom surfaces thereof and a plurality of contacts received in the passageways, respectively. Each contact is spit into an upper terminal and a lower terminal which are mounted into the passageway from opposite surfaces. The upper terminal includes an upper retention portion and an upper engaging portion arcing upwardly from an upper retention portion. The lower terminal includes a lower retention portion and a lower engaging portion arcing downwards from the lower retention portion. The upper and lower engaging portion touch with each other to get an elastic mechanical and electrical connection between the upper and lower engaging portions. The two-piece terminals benefit for the assembly of the contacts. However, the shape of the upper and lower engaging portions in one embodiment is not good for the mechanical connection, or the shape of the upper and lower terminals is not good for optimized electrical connection because of bad high-frequency performance.

Therefore, an improved electrical connector is desired to overcome the disadvantages of the related art.

### SUMMARY OF THE INVENTION

An object of the present invention is to provide an electrical connector with improved terminals.

In order to achieve above-mentioned object, an electrical connector comprises: an insulating housing having an upper face and a lower face, and a plurality of receiving passages and retaining slots communicating with corresponding receiving passages; and a plurality of conductive terminals received in corresponding receiving passages; wherein each of the conductive terminals comprises an upper piece and a lower piece, the upper piece comprises an upper retaining portion retained in the retaining slot, an upper elastic arm slanting upwards, an upper contacting portion above the upper face, and an upper connecting portion slanting downwards from the upper retaining portion, the lower piece comprises a lower retaining portion retained in the retaining slot and below the upper retaining portion, a lower elastic arm slanting downwards, a lower contacting portion below the lower face, and a lower connecting portion slanting upwards from the lower retaining portion, and the upper connecting portion mechanically and electrically connects with the lower retaining portion and the lower connecting portion mechanically and electrically connects with the upper retaining portion.

Other objects, advantages and novel features of the present invention will become more apparent from the following detailed description of the present embodiment when taken in conjunction with the accompanying drawings.

### BRIEF DESCRIPTION OF THE DRAWING

FIG. 1 is a perspective view of an electrical connector of a first embodiment of this present invention, wherein one conductive terminal is taken from an insulating housing;

FIG. 2 is another perspective view of the electrical connector in FIG. 1;

FIG. 3 is a top plane view of the electrical connector in FIG. 1;

FIG. 4 is a cross-sectional view of the electrical connector taken along line A-A in FIG. 1;

FIG. 5 is a cross-sectional view of the electrical connector taken along line B-B in FIG. 1;

FIG. 6 is a perspective view of the conductive terminal in FIG. 1;

FIG. 7 is another perspective view of the conductive terminal in FIG. 6;

FIG. 8 is a front plane view of the conductive terminal in FIG. 6;

FIG. 9 is a side plane view of the conductive terminal in FIG. 6;

FIG. 10 is an exploded perspective view of the conductive terminal in FIG. 6;

FIG. 11 is a perspective view of an electrical connector of a second embodiment of this present invention;

FIG. 12 is a perspective view of a conductive terminal in FIG. 11; and

FIG. 13 is a front plane view of the conductive terminal in FIG. 12.

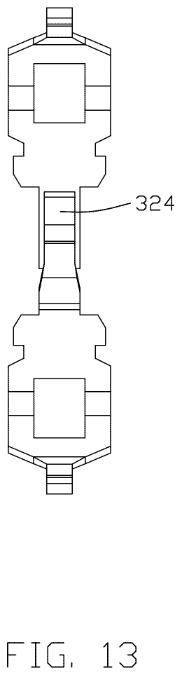

### DETAILED DESCRIPTION OF THE PREFERRED EMBODIMENTS

Reference will now be made in detail to the preferred embodiments of the present invention.

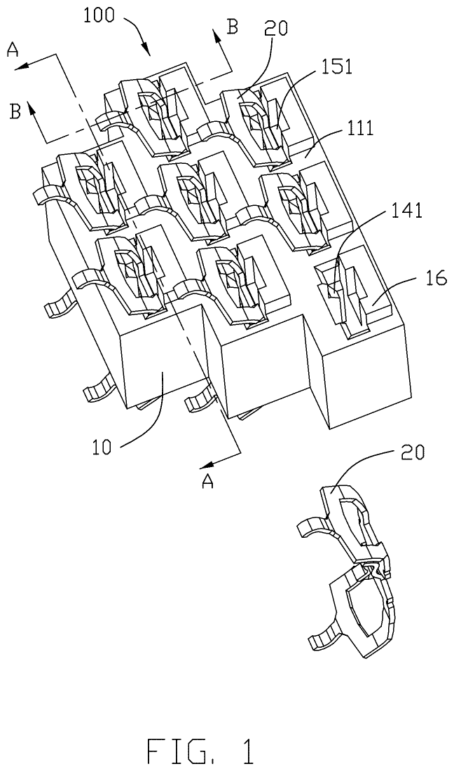

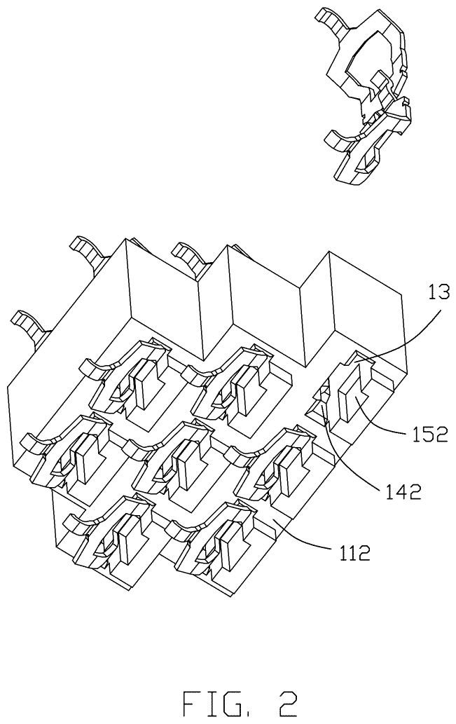

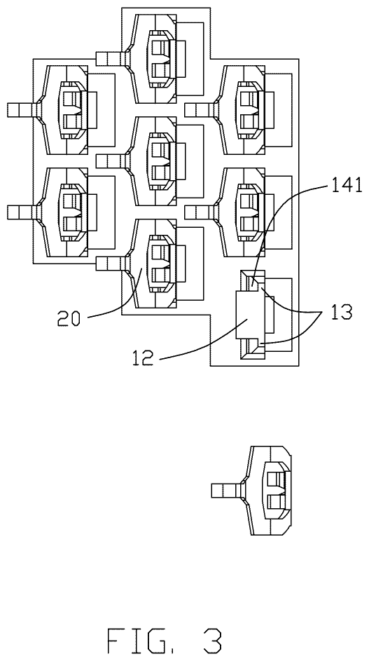

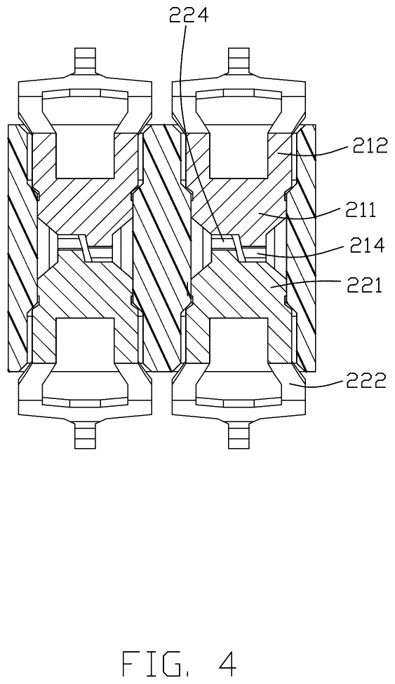

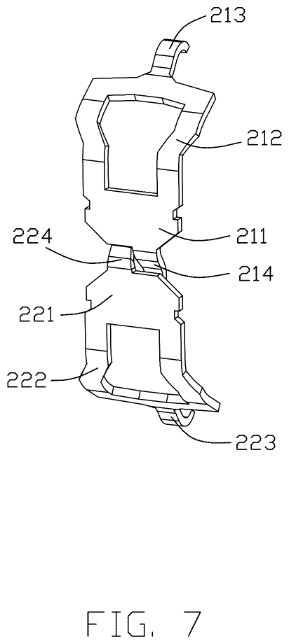

Referring to FIGS. 1-10 illustrating a first embodiment of the present invention, an electrical connector 100 which is only partially figured out in drawings, can be a CPU socket or other IC chip socket connecting between a chip and a circuit board or an interposer connecting between two circuit boards. The electrical connector 100 includes an insulating housing 10 having an upper face 111 and a lower face 112, 1, and a plurality of conductive terminals 20 retained in the housing 10. The insulating housing 10 has a plurality of receiving passages 12 and retaining slots 13 communicating with corresponding receiving passages 12. The conductive terminals 20 are retained in the retaining slots 13 and received in corresponding receiving passages 12, and the plurality of terminals 20 are arranged in an array pattern.

As best shown in FIGS. 1-5, the insulating housing 10 has an upper guiding opening 141 at an entrance of the retaining slot 13 at the upper face 111 and a lower guiding opening 142 at an entrance of the retaining slot 13 at the lower face 112. The insulating housing 10 has an upper groove 151 opening through the upper face 111 and communicating with corresponding receiving passage 12 and a lower groove 152 opening through the lower face 112 and communicating with corresponding receiving passage 12. The insulating housing 10 has a standoff 16 at each of the upper face and the lower face, each of the upper and the lower grooves opens through corresponding standoff 16.

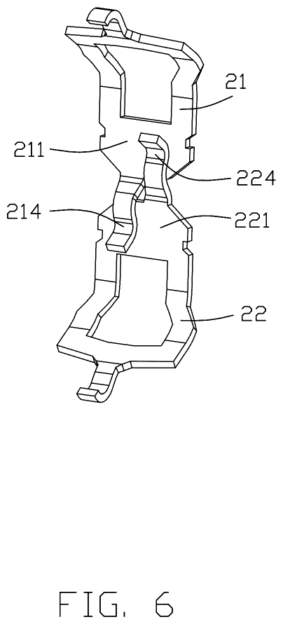

Referring to FIGS. 6-10, each of the conductive terminals 20 includes an upper piece 21 and a lower piece 22 made from a metal piece. The upper piece 21 includes an upper retaining portion 211 retained in the retaining slot 13, an upper elastic arm 212 slanting upwards, an upper contacting portion 213 above the upper face 111 and an upper connecting portion 214 slanting downwards from the upper retaining portion 211. The lower piece 22 includes a lower retaining portion 221 retained in the retaining slot 13 below the upper retaining portion, a lower elastic arm 222 slanting downwards, a lower contacting portion 223 below the lower face and a lower connecting portion 224 slanting downwards from the lower retaining portion 221. The upper connecting portion 214 mechanically connects with the lower retaining portion 221 and the lower connecting portion 224 mechanically connects with the upper retaining portion 211. In this embodiment, the upper piece 21 and the lower piece 22 are identical, the upper pieces 21 are inserted downwards into the retaining slots 13 through the upper face 111, while lower pieces 22 are inserted upwards into the retaining slots 13 through the lower face 112. The upper and lower guiding openings 141, 142 benefit for the insertion of the upper and lower pieces. Moreover, the guiding opening has a larger dimension than the retaining slot 13 to increase the torque of the elastic arm. The upper and lower retaining portions are received in a same retaining slot, to decrease dig of the insulating housing. The upper pieces 21 and the lower pieces 22 not only are made from a same metal strip to get a lower cost of manufacture, but also get a better electric performance.

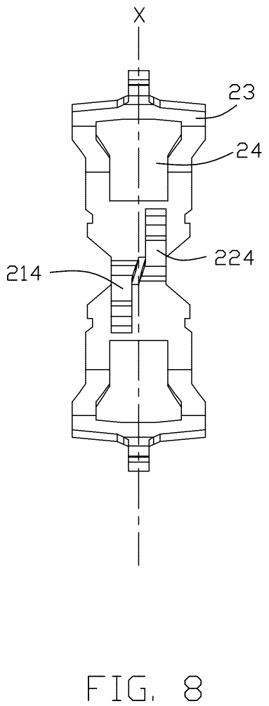

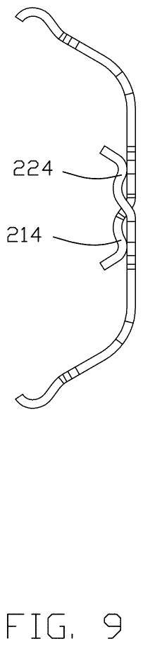

In this embodiment, each of the conductive terminals 20 is composed of two identical metal pieces. Each metal piece 21/22 includes a retaining portion, an elastic arm and a connecting portion extending from opposite edges of the retaining portion, and a contacting portion extending from the elastic arm. The two metal pieces are inserted into the insulating housing 10 from the upper face 111 and the lower face 112 respectively, the retaining portions are retained in corresponding retaining slots 13, the connecting portion of one metal piece contact the retaining portion of another metal piece so as to define one conductive terminal 20. It can be seem that each conductive terminal provide two touch points, thereby defining two parallel circuit through each conductive terminal. The two metal piece stitch from different sides of the insulating separately. The receiving passages are sized to be minimized for fine pitch. A better for SI optimization will be got. The retaining portion is interfered with the retaining slot at opposite lateral sides, and a middle portion of the retaining portion expose to the receiving passage. The connecting portion contacts the middle portion of the retaining portion. That is, the retaining portion provides a connecting point of the two metal pieces, thereby decreasing the dimension of the terminal in the upright direction. The two connecting portions 214, 224 are disposed in the receiving passage 12. Alternatively, the retaining slot 13 can be separated into an upper part and a lower part by a horizontal rib under a condition that the two retaining portions can be received in the retaining slot. As shown in FIG. 8, the retaining portion, the elastic arm and the contacting portion has a common axis X, the connecting portion 214/224 is offset from the common axis X. As shown in FIG. 9, the connecting portion 214/224 has a wave shape which elastically presses against the retaining portion.

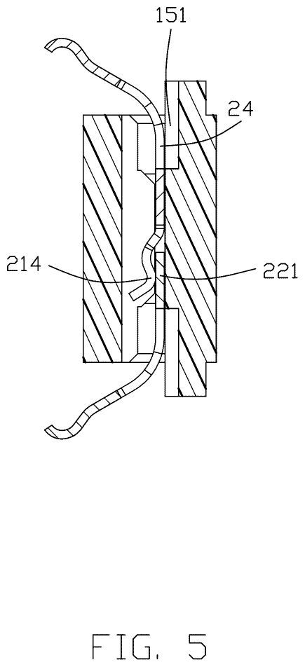

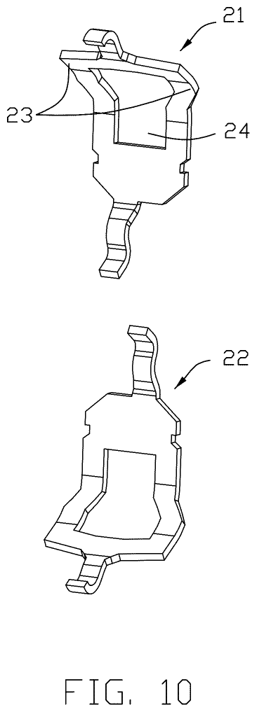

Furthermore, referring to FIG. 8 and FIG. 10, each elastic arm has two widening portions 23 at opposite sides near a free end thereof in a width direction thereof, and an opening 24 therethrough in a thickness direction thereof. The opening 24 extends upward proximate to the upper edge of the elastic arm and the extending downwards proximate to the retaining portion. As best shown in FIG. 5, the lower inner edges of the opening 24 are flushed with the opening 151, 152. A dimension of the upper contacting portion is 0.12 mm in width, which is less than ⅓ of the elastic arm in the width direction. The connecting portion is of an S shape. The opening 24 divides the elastic arm into two beams.

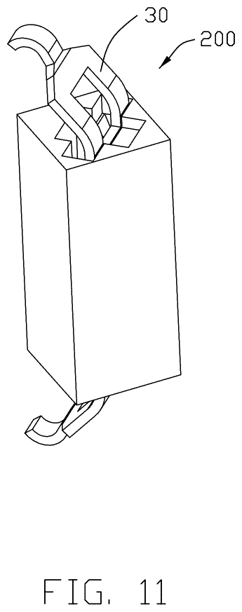

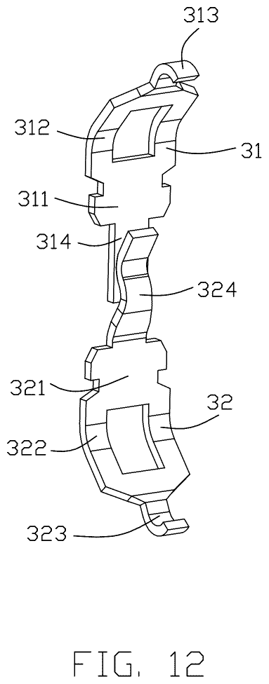

Referring to FIGS. 10-12 illustrating a second embodiment of this present, an electrical connector 200 is similar to the electrical connector 100. Therefore, the difference will be described hereinafter. The upper piece 31 includes an upper retaining portion 311 retained in the retaining slot, an upper elastic arm 312 and an upper connecting portion 314 extending from opposite edges of the upper retaining portion, and an upper contacting portion 313 extending from the upper elastic arm and located above the upper face. The lower piece 32 includes a lower retaining portion 321 retained in the retaining slot, a lower elastic arm 322 and a lower connecting portion 324 extending from opposite edges of the lower retaining portion, and a lower contacting portion 323 extending from the lower elastic arm and located below the lower face. The upper connecting portions mechanically connect with corresponding lower connecting portions respectively. The upper connecting portion 314 is of a blade shape, the lower connecting portion 324 is of a wave shape. The lower connecting portion 324 presses against the upper connecting portion.

However, the disclosure is illustrative only, changes may be made in detail, especially in matter of shape, size, and arrangement of parts within the principles of the invention.

1. An electrical connector comprising:
an insulating housing having an upper face and a lower face, and a plurality of receiving passages and retaining slots communicating with corresponding receiving passages; and
a plurality of conductive terminals received in corresponding receiving passages; wherein
each of the conductive terminals comprises an upper piece and a lower piece, the upper piece comprises an upper retaining portion retained in the retaining slot, an upper elastic arm slanting upwards, an upper contacting portion above the upper face, and an upper connecting portion slanting downwards from the upper retaining portion, the lower piece comprises a lower retaining portion retained in the retaining slot and below the upper retaining portion, a lower elastic arm slanting downwards, a lower contacting portion below the lower face, and a lower connecting portion slanting upwards from the lower retaining portion, and the upper connecting portion mechanically and electrically connects with the lower retaining portion and the lower connecting portion mechanically and electrically connects with the upper retaining portion.

2. The electrical connector as claimed in claim 1, wherein the upper piece and the lower piece are identical.

3. The electrical connector as claimed in claim 1, wherein the insulating has an upper guiding opening at an entrance of the retaining slot at the upper face and a lower guiding opening at an entrance of the retaining slot at the lower face.

4. The electrical connector as claimed in claim 1, wherein the insulating housing has an upper groove opening through the upper face and communicating with a corresponding receiving passage and a lower groove opening through the lower face and communicating with a corresponding receiving passage.

5. The electrical connector as claimed in claim 4, wherein the insulating housing has a standoff at each of the upper face and the lower face, and each of the upper grooves and the lower grooves opens through a corresponding standoff.

6. The electrical connector as claimed in claim 1, wherein each of the upper elastic arm and the lower elastic arm has two widening portions at opposite sides near a free end thereof in a width direction thereof.

7. The electrical connector as claimed in claim 6, wherein each of the upper and lower elastic arms has an opening therethrough in a thickness direction thereof, and the opening extends upward beyond a lower edge of the widening portion.

8. The electrical connector as claimed in claim 1, wherein a dimension of each of the upper and lower contacting portions is smaller than ⅕ of a dimension of each of the upper and lower elastic arms in the width direction.

9. The electrical connector as claimed in claim 1, wherein a dimension of each of the upper and lower contacting portions is 0.12 mm in width.

10. The electrical connector as claimed in claim 1, wherein the upper connecting portions and the lower connecting portions are of a wave shape, and the upper retaining portions and the lower retaining portions are of a blade shape.

11. An electrical connector comprising:
an insulating housing having an upper face and a lower face, and a receiving passage and a retaining slot communicating with the receiving passage; and
two identical metal pieces each comprising a blade retaining portion, an elastic arm and an elastic connecting portion extending from opposite edges of the retaining portion, and a contacting portion extending from the elastic arm;
wherein the two metal pieces are inserted into the insulating housing from the upper face and the lower face respectively, the blade retaining portions are retained in the retaining slot, and the elastic connecting portion of one metal piece are mechanically and electrically connecting with the blade retaining portion of another metal piece so as to define a conductive terminal.

12. The electrical connector as claimed in claim 11, wherein the connecting portions are disposed in the receiving passage.

13. The electrical connector as claimed in claim 11, wherein the retaining portion, the elastic arm, and the contacting portions define a common axis, and the connecting portion is offset from the common axis.

14. The electrical connector as claimed in claim 11, wherein the elastic connecting portion has a wave shape elastically pressing against the blade retaining portion.

15. The electrical connector as claimed in claim 11, wherein the elastic arm has an opening running in a thickness direction of the metal piece.

16. The electrical connector as claimed in claim 15, wherein the contacting portion is larger than the opening in a width direction.

17. An electrical connector comprising:
an insulating housing having an upper face and a lower face, and a plurality of receiving passages and retaining slots commuting with corresponding receiving passages; and
a plurality of conductive terminals received in corresponding receiving passages;
wherein each of the conductive terminals comprises an upper piece and a lower piece, the upper piece comprises an upper retaining portion retained in the retaining slot, an upper elastic arm and an upper connecting portion extending from opposite edges of the upper retaining portion, and an upper contacting portion extending from the upper elastic arm and located above the upper face, the lower piece comprises a lower retaining portion retained in the retaining slot and below the upper retaining portion, a lower elastic arm and a lower connecting portion extending from opposite edges of the lower retaining portion, and a lower contacting portion extending from the lower elastic arm and located below the lower face, the lower connecting portions are of a wave shape and the upper connecting portions are of a blade shape, the lower connecting portions mechanically and electrically connect with corresponding lower connecting portions respectively.

18. The electrical connector as claimed in claim 17, wherein the upper pieces and the lower pieces are identical except the upper connecting portions and lower connecting portions.
